(19) United States
(12) Patent Application Publication
(10) Pub. No.: US 2008/0114876 A1
(43) Pub. Date: May 15, 2008

(54) IMAGE FORMING APPARATUS AND MANAGEMENT SYSTEM OF IMAGE FORMING APPARATUS

(75) Inventor: Katsuhiro Nigorikawa, Kawasaki-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/936,209

(22) Filed: Nov. 7, 2007

Related U.S. Application Data
(60) Provisional application No. 60/865,079, filed on Nov. 9, 2006.

(51) Int. Cl. G06F 15/173

(52) U.S. Cl. 709/224; 709/223

(57) ABSTRACT

A first managing image forming apparatus and a second managing image forming apparatus having a backup function are provided to manage a plurality of image forming apparatus connected to each other through a network. The second managing image forming apparatus is designated or selected by the first managing image forming apparatus. The second managing image forming apparatus substitutively performs a management function when the first managing image forming apparatus is out of order.

### CROSS-REFERENCE TO RELATED APPLICATION

This application is based upon and claims the priority of U.S. Provisional Application No. 60/865,079, filed on Nov. 9, 2006, the entire contents of which are incorporated herein by reference

### BACKGROUND OF THE INVENTION

1. Field of the Invention

The present invention relates to an image forming apparatus connected to a network and a management system of the image forming apparatus.

2. Description of the Related Art

Image forming apparatuses such as digital multi-function peripherals called MFP include a scanner unit and a printer unit. The scanner unit reads an original document, an image processing unit processes the read image data, and the printer unit prints the processed image data.

In recent years, digital multi-function peripherals were known which have a FAX (facsimile) function using a public line in addition to a copy function and a scanner function. Digital multi-function peripherals are also known which are connected to a network and receives print data from external computers to print out the print data in cooperation with the external computers (such as personal computers).

In the digital multi-function peripherals, it is necessary to update software built in the peripherals so as to cope with a new function or to correct functions. The software updating operation is performed directly by a manager or is performed for the individual digital multi-function peripherals by a maintenance man at the time of maintenance.

Accordingly, when plural digital multi-function peripherals are disposed in an office, the operation should be necessarily performed at the site. A variety of setup operations are required to update the software, but a periodical backup operation is also required to restore a software structure to the previous one when any peripheral is out of order. There is a problem in that it is difficult to rapidly repair a disorder by the use of only the maintenance.

A program management system of an image forming apparatus is disclosed in JP-A-2004-42304. In the publication, a model type of an image forming apparatus, a system structure, and version information of a current program are transmitted to a management server and an updating program is downloaded from the management server to perform an update operation.

A management system of an image forming apparatus is disclosed in JP-A-2004-80292. In the publication, plural digital copiers are connected to a management server through a network, a digital copier as a transmission source and a digital copier as a transmission destination are designated by the use of an information terminal device, and setup information of the transmission source is transmitted to the transmission destination through the management server.

However, in the above-mentioned examples, when the management server is out of order, the normal system management cannot be performed until the management server is restored, thereby causing great inconvenience for users. When the management server or the information device in which backup data are stored is out of order and the backup data are erased, there is a problem in that it takes much time to reconstruct data or it is not possible to reconstruct the data in some cases.

JP-A-2003-333234 discloses an image data processing apparatus in which customized setup data of an operation panel in one MFP can be used in an operation panel in another MFP. However, a process of updating various programs in the MFPs is not described in the publication.

JP-A-10-95152 discloses an image forming apparatus which can be connected to another image forming apparatus through an interface. In the publication, plural image forming apparatuses do not affect each other when the individual image forming apparatuses operate in a state where the plural image forming apparatuses are connected to each other.

However, the process of updating various programs in the image forming apparatuses is not described in the publication.

The invention provides an image forming apparatus for reliably maintaining and managing plural digital multi-function peripherals connected to a network and a management system of the image forming apparatus.

### DESCRIPTION OF THE DRAWINGS

FIG. 1 is a network configuration diagram illustrating a management system of image forming apparatuses according to a first embodiment of the invention.

FIG. 2 is a block diagram illustrating a configuration of a first managing image forming apparatus according to the first embodiment of the invention.

FIG. 3 is a block diagram illustrating a configuration of a second managing image forming apparatus according to the first embodiment of the invention.

FIG. 4 is a block diagram illustrating a configuration of another image forming apparatus according to the first embodiment of the invention.

FIG. 5 is a flowchart illustrating an operation of updating or installing control software according to the first embodiment of the invention.

FIG. 6 is a diagram illustrating an update file of the control software according to the first embodiment of the invention.

FIG. 7 is a flowchart illustrating another operation of updating or installing control software according to the first embodiment of the invention.

FIG. 8 is a flowchart illustrating a backup operation at the time of updating the control software or changing setup information according to the first embodiment of the invention.

FIG. 9 is a flowchart illustrating an operation of substitutively performing a management function according to the first embodiment of the invention.

FIG. 10 is a block diagram illustrating a configuration of a first managing MFP according to a second embodiment of the invention.

FIG. 11 is a block diagram illustrating a configuration of another MFP according to the second embodiment of the invention.

FIG. 12 is a block diagram illustrating a configuration for allowing another MFP to substitutively perform the management function according to the second embodiment of the invention.

FIG. 13 is a flowchart illustrating a backup operation and a substitutive management operation according to the second embodiment of the invention.

FIG. 14 is a block diagram illustrating a configuration of a first managing MFP according to a third embodiment of the invention.

### DETAILED DESCRIPTION OF THE INVENTION

Throughout this description, the embodiments and examples shown should be considered as exemplars, rather than limitations on the apparatus of the present invention.

Hereinafter, embodiments of the invention will be described in detail with reference to the drawings.

In the drawings, the same elements are denoted by the same reference numerals.

### First Embodiment

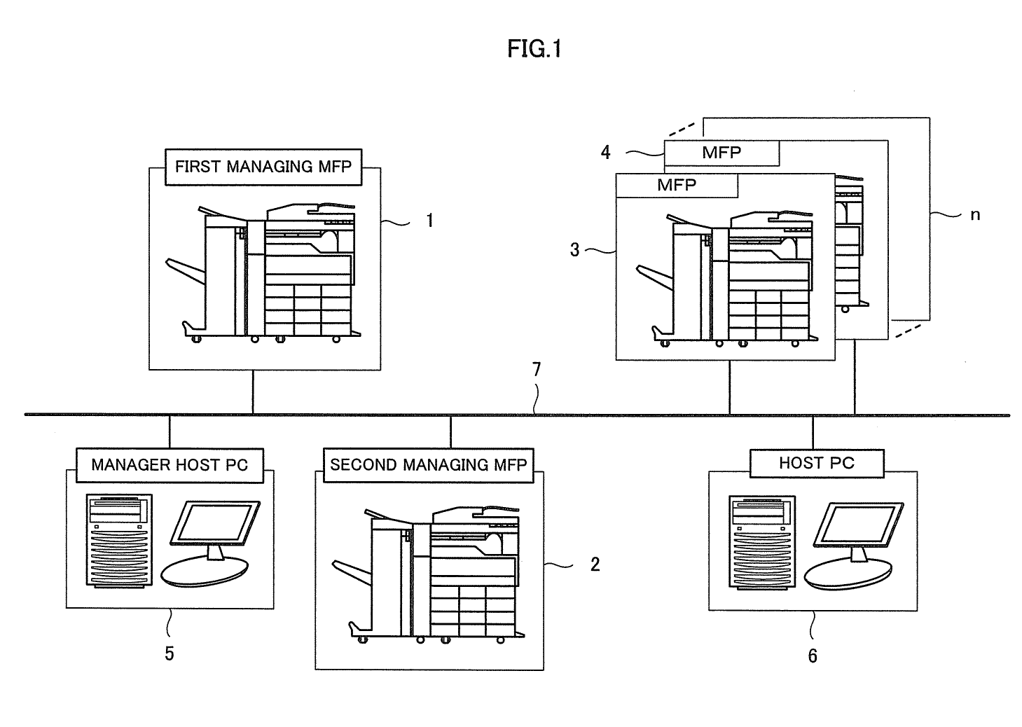

FIG. 1 is a network configuration diagram illustrating a management system of image forming apparatuses according to a first embodiment of the invention.

In the system shown in FIG. 1, image forming apparatuses 1, 2, 3, 4, . . . , n and computers 5 and 6 are connected to each other through a network 7 including a LAN. Reference numerals 1 and 2 denote managing image forming apparatuses and reference numerals 3, 4, . . . , n denote general image forming apparatuses to be managed.

The image forming apparatuses 1, 2, 3, 4, . . . , n are digital multi-function peripherals called MFP. In the following description, the image forming apparatus 1 is referred to as a first managing MFP 1 and the image forming apparatus 2 is referred to as a second managing MFP 2. Regarding the other image forming apparatuses 3, 4, . . . , n, a third MFP 3 and a fourth MFP 4 are representatively described.

The computer 5 is a host personal computer (PC) for a manager and the computer 6 is a general host PC, which are referred to as a manager PC 5 and a PC 6 in the following description. The manager PC 5 and the PC 6 are communicatively connected to the image forming apparatuses 1, 2, 3, 4, . . . , n through the network 7.

In this system, when the first managing MFP 1 normally works, the second managing MFP 2 and other MFPs 3 and 4 are managed in a bundle by the first managing MFP 1 through the network 7. When the first managing MFP 1 cannot normally work due to some disorder, the second managing MFP 2 substitutively performs the management.

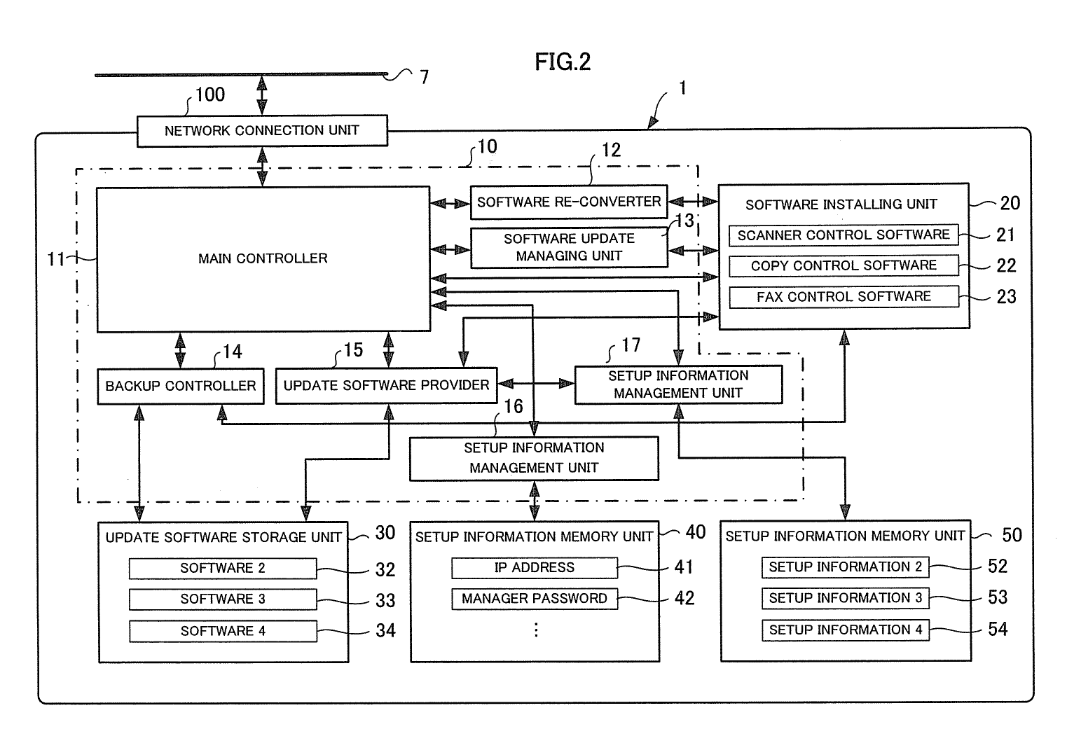

A configuration of an image forming apparatus in a management system according to the first embodiment of the invention will be described now. FIG. 2 is a block diagram illustrating a configuration of the first managing MFP 1 according to the first embodiment of the invention.

As shown in FIG. 2, the first managing MFP 1 has a network connection unit 100 so as to transmit and receive data to and from the manager PC 5, the PC 6, and other MFPs 2, 3, and 4 connected to the network 7.

The first managing MFP 1 includes a control unit 10, a software installing unit 20, an updating software storage unit 30, a first setup information memory unit 40, and a second setup information memory unit 50.

The control unit 10 is connected to the software installing unit 20, the updating software storage unit 30, the first setup information memory unit 40, and the second setup information memory unit 50.

The control unit 10 has a main controller 11 including a CPU or a memory. The main controller 11 is connected to a software re-converter 12, a software update management unit 13, a backup controller 14, an updating software provider 15, a first setup information management unit 16, and a second setup information management unit 17.

The first managing MFP 1 has a scanner unit, a printer unit, and an automatic document feeder (ADF). The scanner unit reads out an image of an original document and the printer unit forms an image on a sheet of paper on the basis of the read data. However, the scanner unit, the printer unit, and the ADF are not shown.

Control software 21, 22, and 23 for controlling various functions of a scanner function, a copy function, and a FAX function of the first MFP 1 are installed in the software installing unit 20. The updated of the control software 21, 22, and 23 are managed by the software update management unit 13.

The software re-converter 12 converts a file format so as to transmit the control software 21, 22, and 23 installed in the software installing unit 20 to the other image forming apparatuses (MFPs) through the network 7.

For example, when an MFP which is the same model as the first managing MFP 1 is connected to the network 7, the control software used in the MFP is equal to the control software used in the first managing MFP 1. Accordingly, the control software 21 to 23 installed in the software installing unit 20 can be converted by the software re-converter 12 and then transmitted to a target MFP.

Control software 32 (software 2) of the second managing MFP2 to be managed, control software 33 (software 3) of the third MFP 3, and control software 34 (software 4) of the fourth MFP 4 are stored in the updating software storage unit 30.

A variety of setup information of the first managing MFP 1 is stored in the first setup information memory unit 40. Data such as a model code of the MFP 1, type or version information of the control software, and updating condition of various setups in addition to an IP address 41 and a manager password 42 are stored as the setup information.

Setup information 52 (setup information 2) of the second managing MFP 2, setup information 53 (setup information 3) of the third MFP 3, and setup information 54 (setup information 4) of the fourth MFP 4 are stored in the second setup information memory unit 50. The setup information 52 to 54 includes model codes of the MFPs 2 to 4 or kind and version information of control software.

A storage medium such as a memory or an HDD is used for the software installing unit 20, the updating software storage unit 30, and the first and second setup information memory units 40 and 50.

The backup controller 14 is connected to the software installing unit 20 and the updating software storage unit 30 and backs up the control software of the MFPs 2, 3, and 4 which are managed over the network 7 and the control software of itself (MFP 1) in cooperation with the second managing MFP 2.

The updating software provider 15 is connected to the updating software storage unit 30 and the second setup information management unit 17 and transmits the control software corresponding to the MFPs 2 to 4 to the MFPS 2 to 4, respectively. The updating software provider 15 manages and checks the model codes of the MFPs 2 to 4 to be managed and the kind and version information of the control software.

The first setup information management unit 16 manages various setup information of the first managing MFP 1 stored in the first setup information memory unit 40. The second setup information management unit 17 manages the setup information 52 of the second managing MFP 2, the setup information 53 of the MFP 3, and the setup information 54 of the MFP 4, which are all stored in the second setup information memory unit 50.

That is, the second setup information management unit 17 receives the setup information transmitted from the MFPs 2, 3, and 4 to be managed to the first managing MFP 1 and stores the received setup information in the second setup information memory unit 50. Details thereof will be described later.

When one of the MFPs 2 to 4, for example, the third MFP 3, is the same model as the first managing MFP 1, the control software 33 of the third MFP 3 is not stored in the updating software storage unit 30, but can be combined with the control software stored in the software installing unit 20. Accordingly, the number of control software stored in the software installing unit 20 and the updating software storage unit 30 can be limited to the minimum.

The control software 32 of the second managing MFP 2 and the control software 33 and 34 of the MFPs 3 and 4 can be managed by a manager's operating the manager PC 5.

The updating control software newly prepared is uploaded to the updating software storage unit 30 and updated by the manager PC 5. At this time, a previous differential file is stored in addition to a differential file between the updated control software file and the previous file.

The control software 21 to 23 of the software installing unit 20 is similarly updated and installed in the software installing unit 20 by the manager.

When the updating control software of the first managing MFP 1 is uploaded, the software update management unit 13 or the updating software provider 15 transmits the updating control software to the second managing MFP 2 and the third and fourth MFPs 3 and 4 to be managed.

When an MFP which is the same model as the first managing MFP 1 is connected to the network 7 and the updating control software is installed in the software installing unit 20, the updating control software is transmitted to the corresponding MFP. Alternatively, after the installation is ended, the updating control software may be converted into a transmittable format by the software re-converter 12 and then may be transmitted.

The backup controller 14 transmits the updated control software to the second managing MFP 2. Accordingly, the backup data of the control software of the MFPs 1 to 4 are stored in the second managing MFP 2.

In addition, the software update management unit 13 is not necessarily provided and the update condition may be managed by the updating software provider 15.

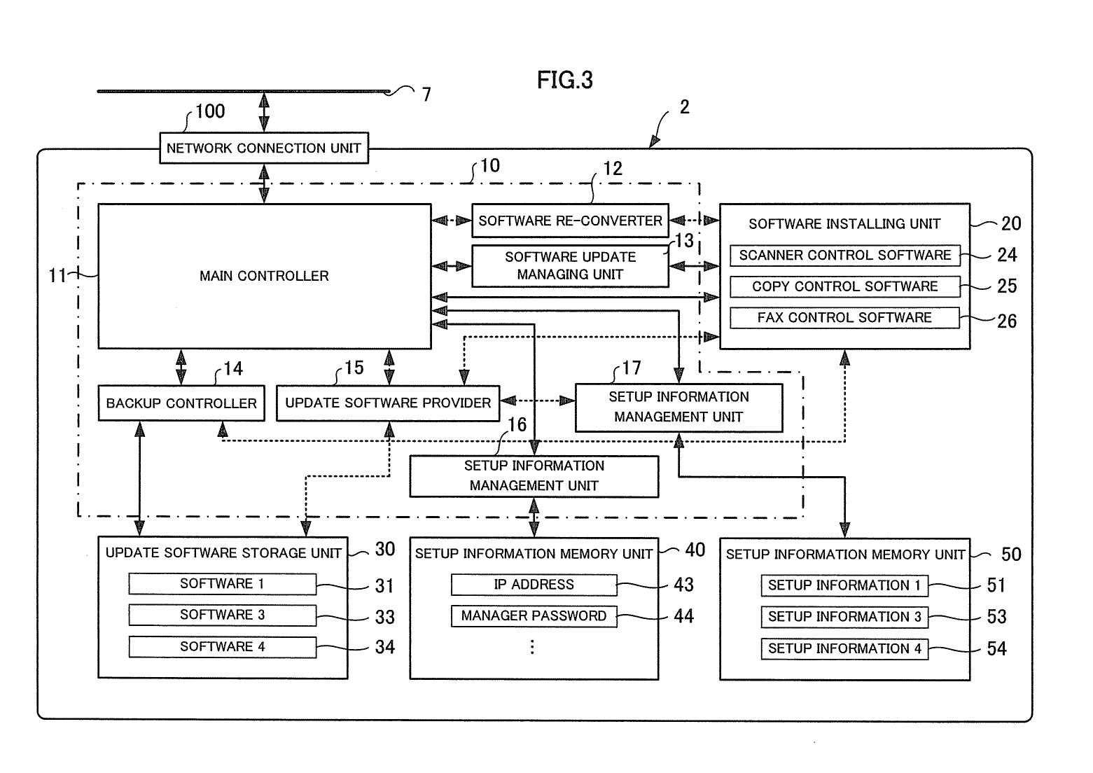

The configuration of the second managing MFP 2 in the management system according to the first embodiment of the invention will be described now with reference to FIG. 3.

FIG. 3 is a block diagram illustrating a configuration of the second managing MFP 2. Elements having the same functions as FIG. 2 are denoted by the same reference numerals.

As shown in FIG. 3, the second managing MFP 2 has the same configuration as the first managing MFP 1 and can transmit and receive data to and from the first managing MFP 1, the other MFPs 3 and 4, and the PCs 5 and 6 through the network connection unit 100.

The second managing MFP 2 includes a controller 10, a first software installing unit 20, an updating software storage unit 30, a first setup information memory unit 40, and a second setup information memory unit 50.

The control unit 10 has a main controller 11 including a CPU or a memory. The main controller 11 is connected to a software re-converter 12, a software update management unit 13, a backup controller 14, an updating software provider 15, a first setup information management unit 16, and a second setup information management unit 17.

The second managing MFP 2 includes a scanner unit, a printer unit, and an automatic document feeder (ADF), which are not shown.

In the second managing MFP 2, control software 24, 25, and 26 for controlling a scanner function, a copy function, and a FAX function of the MFP2 itself are installed in the software installing unit 20.

Control software 31 (software 1) of the first managing MFP 1, Control software 33 (software 3) of the third MFP 3, and control software 34 (software 4) of the fourth MFP 4 are stored in the updating software storage unit 30.

Setup information such as an IP address 43 and a manager password 44 of the MFP 2 is stored in the first setup information memory unit 40. Setup information 51 (setup information 1) of the first managing MFP 1, setup information 53 (setup information 3) of the third MFP 3, and setup information 54 (setup information 4) of the fourth MFP 4 are stored in the second setup information memory unit 50.

The software update management unit 13 accesses the first managing MFP 1 at the time of startup or periodically, or in response to a command signal from the first managing MFP 1. When newer control software than the control software 24, 25, and 26 installed in advance in the software installing unit 20 is updated in the first managing MFP 1 at the time of access, the software update management unit receives the new control software from the first managing MFP 1 through the network 7 and installs the received control software in the software installing unit 20.

The backup controller 14 is connected to the software installing unit 20 and the updating software storage unit 30 and backs up the control software and the setup information of the MFP connected to the network 7 in cooperation with the first managing MFP 1.

The backup control software transmitted from the first managing MFP 1 through the backup controller 14 is stored in the updating software storage unit 30. The backup setup information transmitted from the first managing MFP 1 through the second setup information management unit 17 is stored in the second setup information memory unit 50.

The updating software provider 15 is connected to the second setup information management unit 17 and the updating software storage unit 30 and manages and checks the model codes of the MFPs 1, 3, and 4 to be managed and the kind and version information of the control software. The updating software provider can transmit the control software corresponding to the MFPs 1, 3, and 4 to the MFPs 1, 3, and 4.

The first setup information management unit 16 manages the setup information 43 and 44 stored in the first setup information memory unit 40 and transmits the setup information 43 and 44 to the first managing MFP 1 at a predetermined time point.

Even when the IP address or the manager password is changed due to a change in position of the second managing MFP 2 or a change of the manager, the first setup information management unit 16 transmits the changed setup information 43 and 44 to the first managing MFP 1.

The second setup information management unit 17 manages the setup information 51 of the first managing MFP 1, the setup information 52 of the MFP 3, and the setup information 54 of the MFP 4, which are stored in the second setup information memory unit 50.

A signal line indicated by a dotted arrow in FIG. 3 does not work in a circuit manner when the first managing MFP 1 works normally, but works in a circuit manner when the first managing MFP 1 does not work due to some disorder.

The updating software provider 15 and the software re-converter 12 work when the first managing MFP 1 does not work due to some disorder.

The second managing MFP 2 recognizes the working condition of the first managing MFP 1 by allowing the backup controller 14 to access the first managing MFP 1 periodically, for example, every minute.

When the first managing MFP 1 works normally, the backup controller 14 backs up the control software such as scanner software, copy software, and FAX software of the first managing MFP 1 and the control software or the setup information of the MFPs 3 and 4.

When recognizing that the first managing MFP 1 does not work, the second managing MFP 2 manages the MFPs 3, 4, . . . over the network 7 instead of the first managing MFP 1 by automatically starting up the management function.

When recognizing that the first managing MFP 1 does not work, the second managing MFP manually starts up the management function of the second managing MFP 2 by informing the manager PC 5 of the fact.

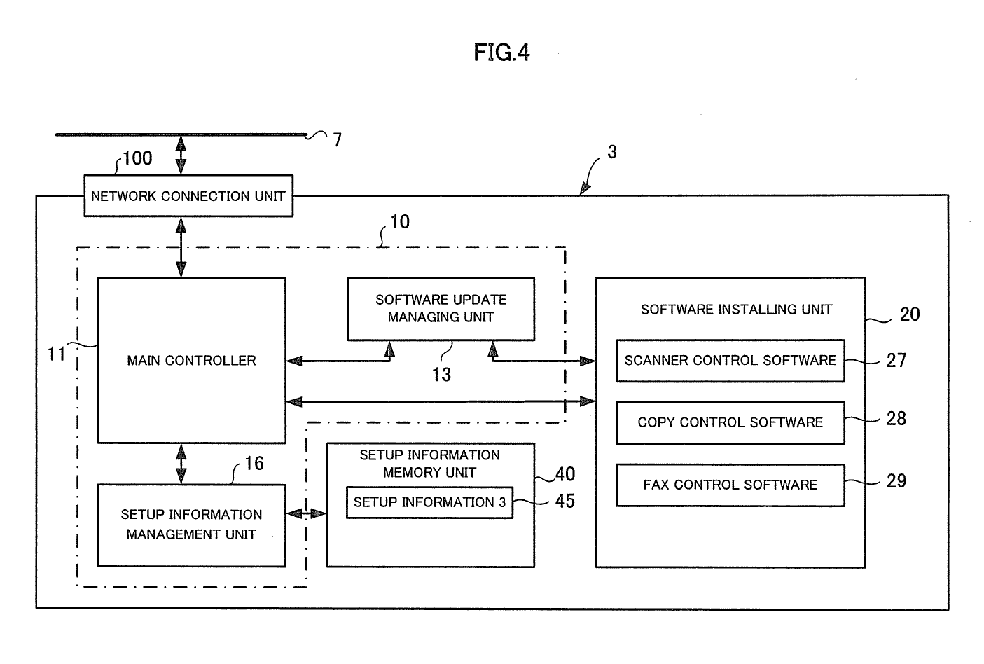

A configuration of another image forming apparatus (MFP 3, 4, . . . , or n) in the management system according to the first embodiment of the invention will be described with reference to FIG. 4.

FIG. 4 is a block diagram illustrating a configuration of the MFPs 3, 4, . . . , where the third MFP 3 is exemplified. Elements having the same functions as FIG. 2 and FIG. 3 are denoted by the same reference numerals.

The third MFP 3 includes a network connection unit 100, a control unit 10, a software installing unit 20, and a setup information memory unit 40. The control unit 10 has a main controller 11 including a CPU or a memory. The main controller 11 is connected to a software update management unit 13 and a setup information management unit 16.

The third MFP 3 includes a scanner unit, a printer unit, and an automatic document feeder (ADF), which are not shown.

In the third MFP 3, control software 27, 28, and 29 for controlling a scanner function, a copy function, and a FAX function are installed as the control software of the MFP 3 in the software installing unit 20.

Setup information 45 (setup information 3) such as the model code, the kind and version information of the control software and update state of various setup, in addition to an IP address and a manager password of the MFP 3 is stored in the setup information memory unit 40.

The setup information management unit 16 manages the setup information 45 stored in the setup information memory unit 40.

The software update management unit 13 accesses the first managing MFP 1 at the time of startup of MFP 3 or periodically, or in response to a command signal from the first managing MFP 1. When newer control software than the control software 27, 28, and 29 installed in advance in the software installing unit 20 is updated in the first managing MFP 1 at the time of access, the software update management unit receives the new control software through the network 7 and installs the received control software in the software installing unit 20.

When the IP address or the manager password is changed due to a change in position of the third MFP 3 or replacement of the manager, the setup information management unit 16 transmits the changed setup information 45 to the first managing MFP 1.

On the other hand, when a change command for the IP address or the manager password is given from the first managing MFP 1, the setup information management unit 16 changes the setup information 45 stored in the setup information memory unit 40 of the third MFP 3.

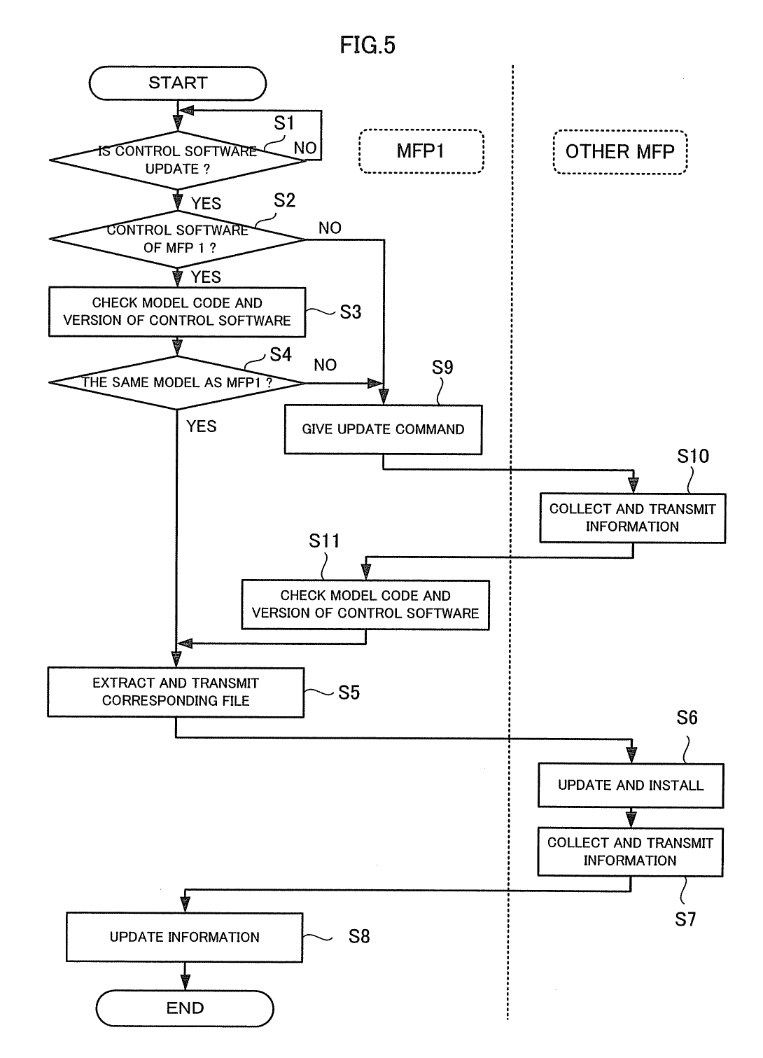

An action of the management system of image forming apparatuses according to the first embodiment of the invention will be described now with reference to FIGS. 5 to 9.

The command of print etc. to the first managing MFP 1, the second managing MFP 2, and the MFPs 3 and 4 can be given from any one of the manager PC 5 and the PC 6. The update or installation of the updating control software to the first managing MFP 1 can be directly performed by the use of the manager PC 5 or a CD-R or memory.

The unique setup information of the MFPs including the first managing MFP 1 can be changed, for example, by an operation of an operation panel of the MFPs or a merged management of the manager host PC 5.

First, an action when new control software is updated or installed in the first managing MFP 1 is described with reference to FIG. 5. The left of FIG. 5 shows a flow of processes of the first managing MFP 1 and the right thereof shows a flow of processes of the other MFPs 2, 3, and 4 to be managed.

In FIG. 5, it is determined in step S1 whether the control software has been updated.

For example, when the control software is updated by the manager host PC 5 or by the use of a recording medium such as a memory, the process of step S2 is performed. In step S2, it is determined whether the updated control software is one of the control software 21 to 23 of the first managing MFP 1.

When it is determined in step S2 that the updated control software is one of the control software 21 to 23 of the first managing MFP 1, new control software is installed in the software installing unit 20 by the software update management unit 13 in step S3.

In step S3, the model code of the MFPs to be managed or the version information of the control software are checked by the second setup information management unit 17.

In step S4, it is determined whether any of the MFPs to be managed is the same model as the first managing MFP 1. Here, it is assumed that the third MFP 3 is the same model as the first managing MFP 1.

When it is determined in step S4 that there is the same model, the files corresponding to the control software 21 to 23 of the first managing MFP 1 are extracted and transmitted to the MFP 3 in step S5.

Accordingly, the MFP 3 which is the same model as the first managing MFP 1 updates and installs the control software 21 to 23 of the first managing MFP 1 in step S6.

When the update and installation is ended, the MFP 3 collects the setup information thereof such as the IP address and manager password, the model code, and the version information of the control software and transmits the collected setup information to the first managing MFP 1 in step S7.

The first managing MFP 1 having received the transmission information from the MFP 3 stores and updates the received setup information in the second setup information memory unit 50 in step S8. The MFP having new control software installed therein is restarted up as needed.

On the other hand, when it is determined in step S2 that the newly updated control software is not the control software of the first managing MFP 1, or when it is determined in step S4 that there is no MFP which is the same model as the first managing MFP 1, the process of step S9 is performed.

Information for an update command is transmitted to the second managing MFP 2 and another MFP 4 through the updating software provider 15 of the first managing MFP 1 in step S9.

The second managing MFP 2 and another MFP 4 having received the information for an update command collect the setup information such as the IP address of itself or manager password, the model code, and the version information of the control software and transmit the collected setup information to the first managing MFP 1 in step S10.

The first managing MFP 1 having received the transmission information from the second managing MFP 2 and the MFP 4 checks the model codes of the MFPs or the version information of the control software in step S11. The first managing MFP extracts a file corresponding to the control software updated in step S5 and transmits the extracted file to the second managing MFP 2 or the MFP 4.

The second managing MFP 2 or the MFP 4 having received the file corresponding to the updated control software performs the update and installation in step S6 when determining that the corresponding file can execute program properly by the corresponding MFP.

The MFP having performed the update and installation collects the updated setup information and transmits the collected setup information to the first managing MFP 1 in step S7. The MFP having updated the new control software is restarted as needed.

The first managing MFP 1 having received the transmission information transmitted after the update updates the information by transmitting the received information to the second setup information memory unit 50 in step S8.

In step S6, the second managing MFP 2 and the MFP 4 are allowed to determine whether the corresponding file can be executed properly in program. However, this determination may be performed when the first managing MFP 1 receives the transmission information in step S5 and the updating control software may be transmitted to the corresponding MFP.

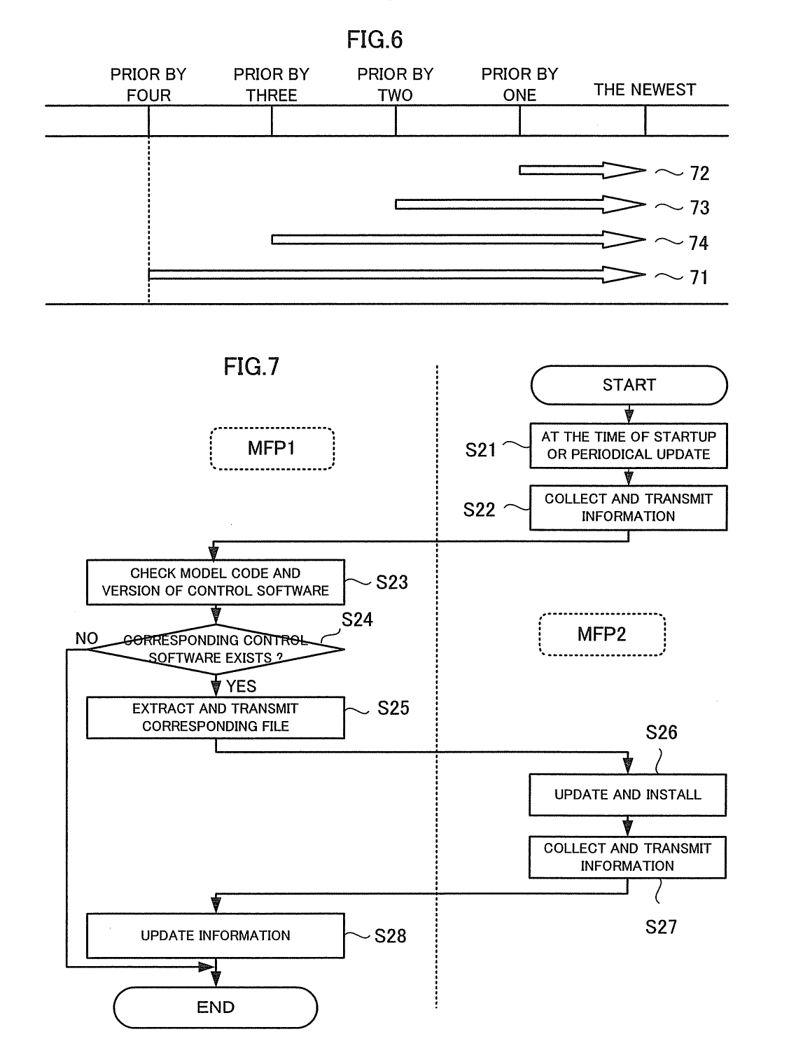

FIG. 6 is a diagram illustrating the corresponding file to be transmitted to another MFP in step S6.

As the corresponding file, the entire file of the control software may be transmitted, or a differential file between the currently installed control software and the newest control software may be transmitted to the MFPs to be managed.

In FIG. 6, reference numeral 71 denotes the entire file and reference numerals 72, 73, and 74 denote the differential files. The differential file 72 contains a difference between the newest version and the version just prior thereto, the differential file 73 contains a difference between the newest version and the version prior thereto by two versions, and the differential file 74 contains a difference between the newest version and the version prior thereto by three versions.

When the control software is updated, it is general that one of the differential files 72 to 74 are received and updated. When the MFP to be managed is out of order, hardware is replaced, the information is initialized, or when old control software prior to a predetermined time is used, the entire control software is replaced and updated by the use of the entire file 71.

Operations which are started from the MFPs 2, 3, and 4 to be managed to acquire new control software will be described now with reference to FIG. 7.

This shows a control software updating operation, for example, when new control software is updated in the first managing MFP 1 and the power supplies of the MFPs 2, 3, and 4 to be managed are turned off.

The second managing MFP 2 or the MFPs 3 and 4 start its operation at the time of startup in step S21, at the time of connection to the network 7, or at the time of periodical update. In step S22, the setup information such as the IP address or manager password, the model code, and the version information of the control software is collected and transmitted as the transmission information to the first managing MFP 1. Here, the periodical updating time can be set freely, for example, every minute.

When receiving the transmission information from the second managing MFP 2 or the MFPs 3 and 4, the first managing MFP 1 checks the model codes of the MFPs to be managed or the version information of the control software in step S23.

The first managing MFP 1 determines in step S24 whether the newest control software stored in the first managing MFP 1 is newer than the received version information of the control software.

When determining that the control software stored in the first managing MFP 1 is new one, the first managing MFP 1 extracts a file corresponding to the newest control software of the second managing MFP2 or the MFPs 3 and 4 and transmits the extracted file in step S25.

The second managing MFP 2 or the MFPs 3 and 4 having received the newest corresponding file perform the update and installation in step S26. After the update and installation is ended, the updated setup information is collected and transmitted to the first managing MFP 1 in step S27.

The first managing MFP 1 having received the updated setup information updates and stores the received setup information in the second setup information memory unit 50 in step S28. When the control software is not changed in step S24, the updating process is not performed and the flow is ended.

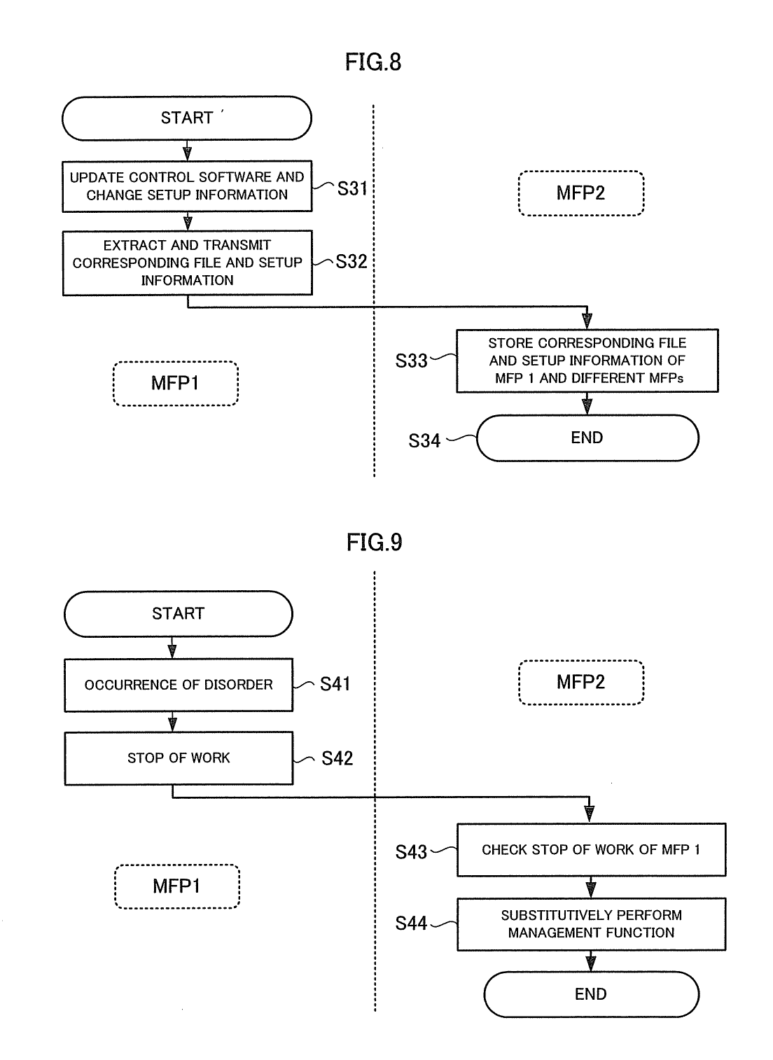

A backup operation at the time of updating the control software or at the time of changing and updating the setup information will be described with reference to FIG. 8.

In FIG. 8, step S31 indicates a case where the control software stored in the first managing MFP 1 is updated or a case where the setup information of the MFPs including the first managing MFP 1 is changed.

The setup information of the MFP can be changed by operating the operation panel of each MFP or can be changed under the merged management of the manager PC 5 by the use of the first managing MFP 1. The changed setup information is stored in the first setup information memory unit 40 or the second setup information memory unit 50 of the first managing MFP 1.

When the control software stored in the first managing MFP 1 is updated, or when the setup information of each MFP is changed, the backup controller 14 and the second setup information management unit 17 of the first managing MFP 1 extracts the file corresponding to the updated control software and the setup information in step 32 and transmits the extracted data to the second managing MFP 2. At this time, the transmitted data may contain only a differential file of the updated portion or the entire file.

The backup controller 14 and the second setup information management unit 17 of the second managing MFP 2 having received the updated control software or the setup information stores the received data in the updating software storage unit 30 and the second setup information memory unit 50 of the second managing MFP 2 and performs the backup operation in step S33.

An operation when the first managing MFP 1 is out of order and thus does not work will be described now with reference to FIG. 9.

In FIG. 9, step S41 means a case where the first managing MFP 1 is out of order and step S42 shows a case where the first managing MFP 1 stops its work.

When the first managing MFP 1 cannot manage the second managing MFP 2 and the MFPs 3 and 4 to be managed due to the stop of work thereof, the second managing MFP 2 manages the MFPs 3 and 4 over the network 7 instead of the first managing MFP 1.

The second managing MFP 2 periodically accesses the first managing MFP 1 and recognizes that the first managing MFP 1 stops its work in step S43 when no response to the access to the first managing MFP 1 is returned or when it cannot access the first managing MFP 1.

The access time to the first managing MFP 1 is set to have, for example, a 1-minute interval so as not to cause a great disorder in the management system.

When the second managing MFP 2 recognizes the stop of a function of the first managing MFP 1, the signal line indicated by the dotted line in FIG. 3 works in a circuit manner, and the updating software provider 15 and the software re-converter 12 operate.

That is, the second managing MFP 2 has the same function as the first managing MFP 1 and substitutively performs the management function in step S44. The second managing MFP 2 notifies the manager PC 5 of the fact of substitutively performing the management function.

According to the first embodiment of the invention, the updating of the control software of the MFPs, the change of the setup information, and the like can be managed in a bundle by the first managing MFP 1. Accordingly, it is not necessary to individually set up the MFPs and it is thus possible to enhance workability of a manager.

Since the MFPs over the network 7 can be managed in a bundle by the use of the first managing MFP 1, it is not necessary to provide a particular management server, thereby reducing cost.

When the first managing MFP 1 is out of order, the second managing MFP 2 substitutively performs the management function and thus it is possible to perform normal system management. In addition, the second managing MFP 2 is made to have a backup function. Accordingly, even when data of the first managing MFP 1 is erased, the second managing MFP 2 can rapidly do some maintenance.

When the control software of the first managing MFP 1 is updated, the control software is soon transmitted and installed to and in an MFP which is the same model as the first managing MFP 1, thereby enhancing the updating workability.

Plural MFPs for performing the management instead of the first managing MFP 1 may be provided. In this case, the priority order may be given to the plurality of MFPs and the management function may be substitutively performed in the priority order when the first managing MFP 1 stops its work.

The updating condition of the control software can be checked from a display of the manager PC 5 or the operation panel of the first managing MFP 1. In the updating information displayed on the display or the operation panel, the displayed characters may be changed in color or may have some symbols attached thereto.

Although it has been shown in FIGS. 2 and 3 that the first setup information memory unit 40 and the second setup information memory unit 50 are provided, the memory units may be embodied in a single memory medium. The first setup information management unit 16 and the second setup information management unit 17 may also be embodied in a single setup information management unit.

### Second Embodiment

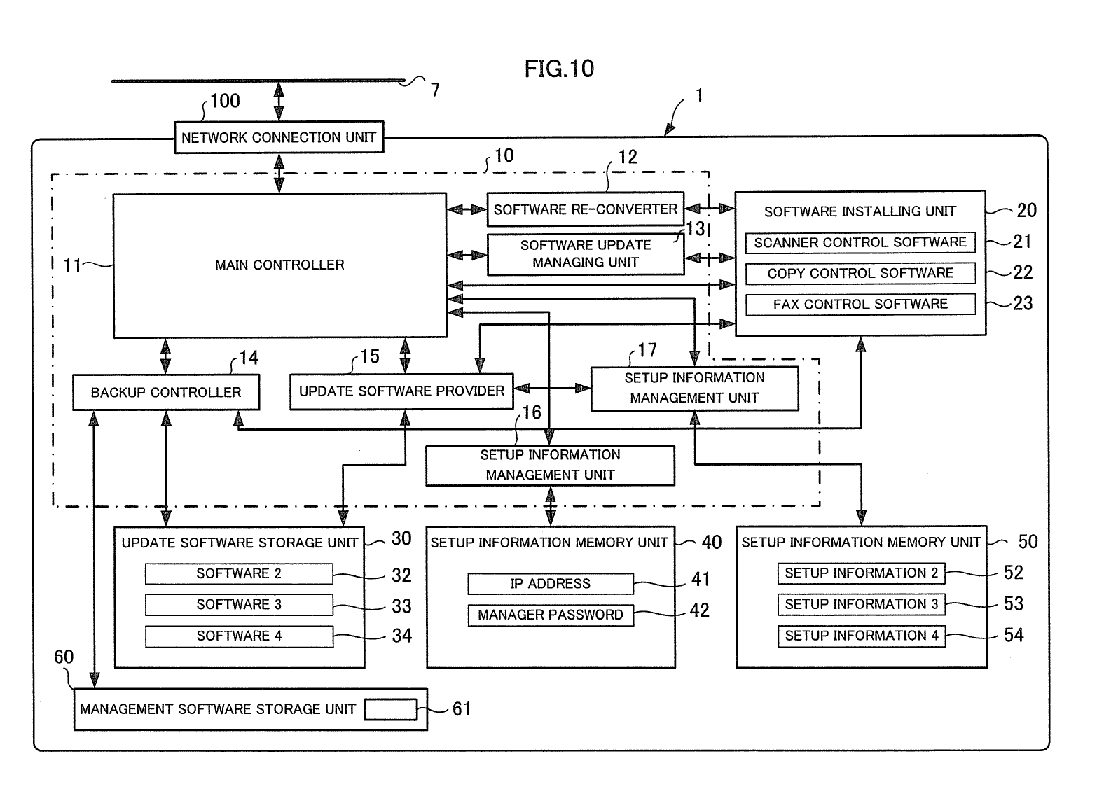

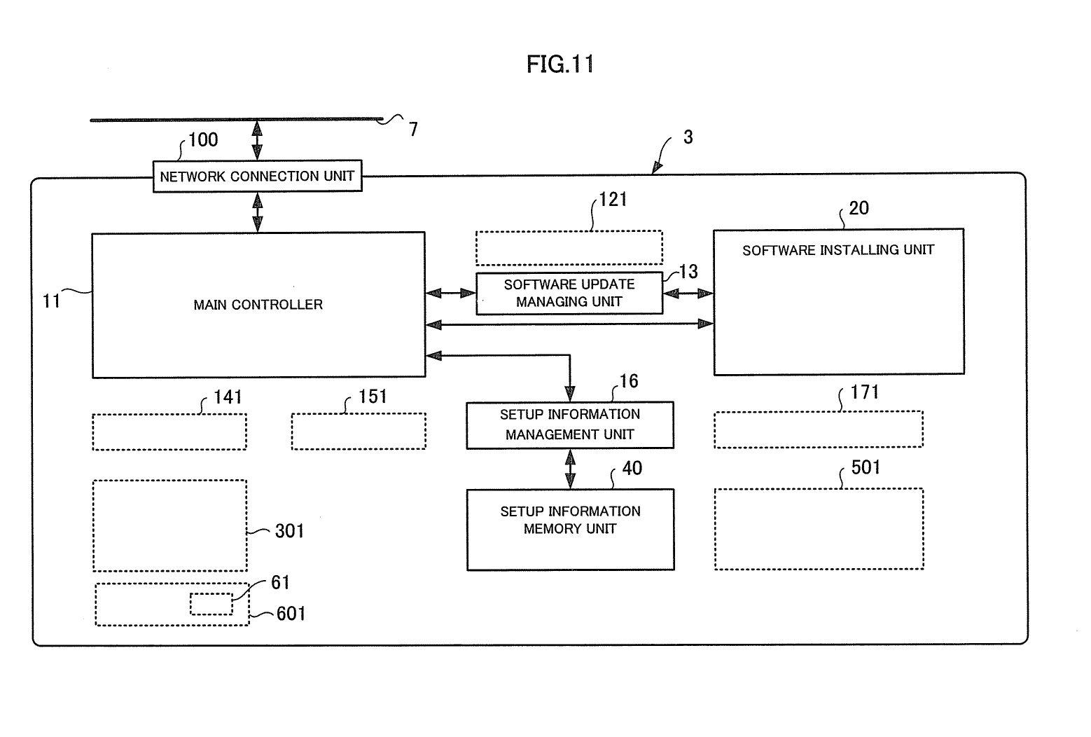

A management system of image forming apparatuses according to a second embodiment of the invention will be described with reference to FIGS. 10 and 11. Elements having the same functions as those of the first embodiment are denoted by the same reference numerals.

In the second embodiment, the MFP for performing a management function instead of the first managing MFP 1 can be selected from plural MFPs 2, 3, and 4. In this embodiment, it is assumed that the third MFP 3 is selected.

FIG. 10 is a block diagram illustrating a configuration of the first managing MFP 1 in a management system according to the second embodiment of the invention. FIG. 11 is a block diagram illustrating a configuration of the MFP 3 for substitutively performing the management function.

That is, as shown in FIG. 10, the first managing MFP 1 according to the second embodiment additionally has a management software storage unit 60 and the management software storage unit 60 is connected to the backup controller 14.

On the other hand, as shown in FIG. 11, the MFP 3 has the same configuration as being shown in FIG. 4 and includes a main controller 11, a software update management unit 13, a software installing unit 20, a setup information management unit 16, and a setup information memory unit 40.

In FIG. 11, a storage medium such as a memory or an HDD is used for the software installing unit 20 and the setup information memory unit 40, and memory areas 301 and 501 corresponding to the updating software storage unit 30 and the setup information memory unit 50 shown in FIG. 3 are disposed therein.

The MFP 3 of FIG. 11 includes memory areas 121, 141, 151, and 171 constituting the software re-converter 12, the backup controller 14, the updating software provider 15, and the second setup information management unit 17 shown in FIG. 3.

Management software 61 is stored in the management software storage unit 60 of the first managing MFP 1 and the management software 61 can be transmitted to the third MFP 3. When the third MFP 3 receives the management software 61, the third MFP 3 installs the management software 61 therein.

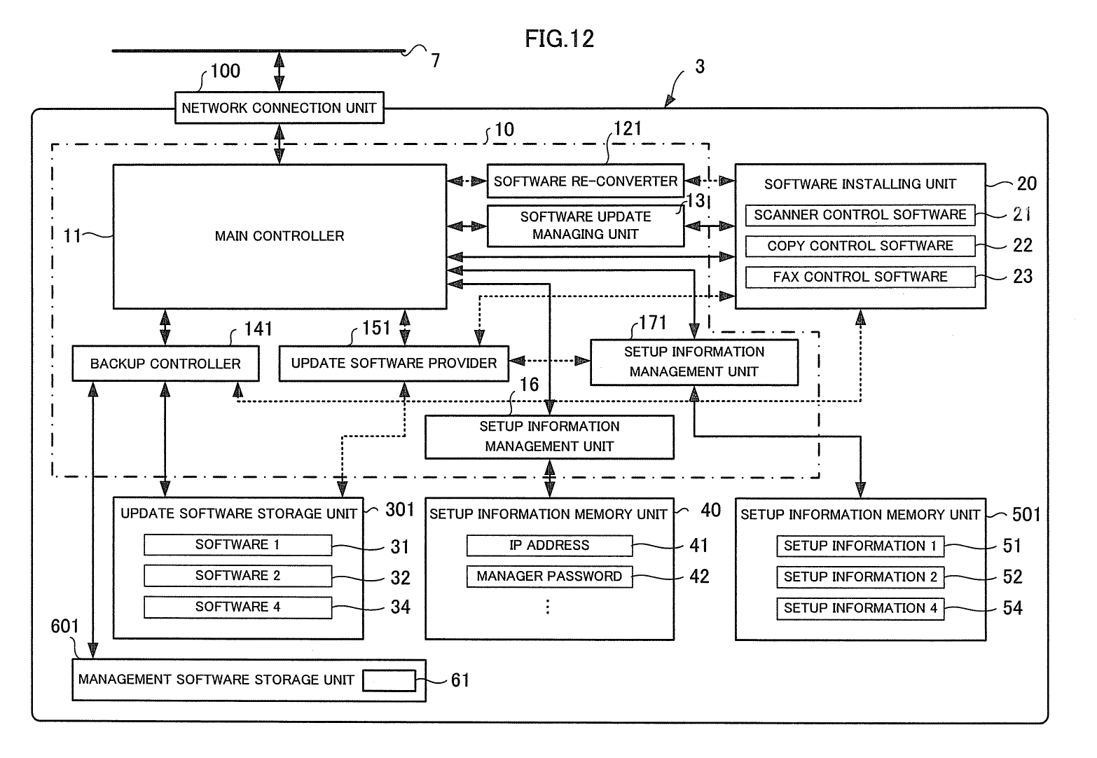

The software re-converter 121, the backup controller 141, the updating software provider 151, and the setup information management unit 171 shown in FIG. 12 are embodied in the third MFP 3 by the installed management software 61 using the built-in memory areas 301 and 501 and the memory areas 121, 141, 151, and 171.

Accordingly, the third MFP 3 constructs the circuit configuration shown in FIG. 12 when it is selected as the managing MFP. The transmitted management software 61 is stored in the management software storage unit 601 embodied by the backup controller 141.

The substitutive management function and the backup function according to the second embodiment will be described now.

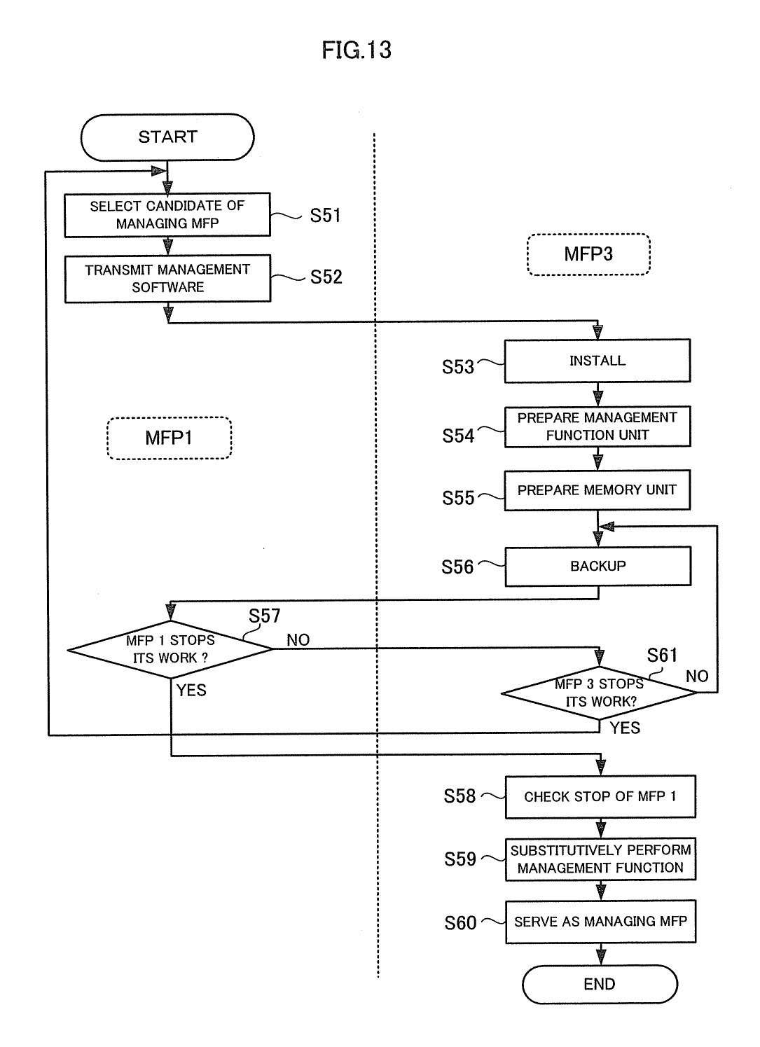

FIG. 13 is a flowchart illustrating a flow of processes of the management system according to the second embodiment.

First, the first managing MFP 1 selects a candidate of the managing MFP from the MFPs 2, 3, and 4 to be managed in step S51. Here, it is assumed that the third MFP 3 is selected as the candidate.

When the third MFP 3 is selected, the backup controller 14 transmits the management software 61 stored in the management software storage unit 60 to the third MFP 3 through the network 7 in step S52.

The third MFP 3 having received the management software 61 stores the management software 61 in the management software storage unit 601 in step S53.

When the management software 61 is installed, management function units such as the backup controller 141, the updating software provider 151, and the second setup information management unit 171 are prepared in the third MFP 3 in step S54.

In step S55, the updating software storage unit 301 and the management software storage unit 601 are prepared by the backup controller 141 prepared in the third MFP 3, and the second setup information memory unit 501 is prepared by the second setup information management unit 171.

Here, since the third MFP 3 has a function as the managing MFP, it is referred to as the managing MFP3 in the following description.

In step S56, the control software of the first managing MFP 1 and the control software of the other MFPs 2 and 4 are transmitted to the managing MFP 3. Accordingly, the backup controller 141 stores the transmitted control software in the updating software storage unit 301, stores the management software 61 in the management software storage unit 601, and then performs the backup operation.

The second setup information management unit 171 stores the setup information 51 of the first managing MFP 1 transmitted from the first managing MFP 1 and the setup information 52 and 54 of the second and fourth MFPs 2 and 4 in the second setup information memory unit 501 and then performs the backup operation.

When it is determined in step S57 that the first managing MFP 1 is out of order and the management function does not work, the managing MFP 3 recognizes that the first managing MFP 1 stops its function in step S58.

Accordingly, the managing MFP 3 substitutively performs the management function in step S59 and manages the other MFPs instead of the first managing MFP 1 in step S60.

On the other hand, when it is determined in step S57 that the first managing MFP 1 is not out of order and it is determined in step S61 that the managing MFP 3 is not out of order, the managing MFP 3 continues to perform the backup operation in step S56.

When it is determined in step S61 that the managing MFP 3 is out of order, the first managing MFP 1 selects a candidate of a new managing MFP from the MFPs connected to the network 7 in step S51 again.

In the above-mentioned description, the MFP 3 is selected as the first managing candidate. However, the other MFPs 4, . . . can be the candidate of the managing MFP by having the same configuration as FIG. 11.

The method of selecting the candidate is not particularly limited. For example, a method of selecting an MFP having many resources or a method of selecting an MFP having the smallest use frequency on the basis of the number of printing materials and the like may be used.

According to the second embodiment of the invention, the candidate of the managing MFP can be selected by the first managing MFP 1. Accordingly, when the first managing MFP 1 is out of order, another MFP can substitutively perform the management function.

Therefore, it is possible to prevent the loss of backup data or the stop of the management operation such as the updating of control software and thus the restoration operation can be easily performed even when the managing MFP is out of order. It is possible to suppress the system disorder to the minimum, thereby obtaining high workability and maintenance.

In the second embodiment, when it is intended to select a candidate of the managing MFP, the candidate can be selected in accordance with a command from the manager PC 5 or can be directly selected by a manager having arrived at locations of the MFPs to be managed.

Although it is shown in FIG. 12 that the first setup information memory unit 40 and the second setup information memory unit 501 are provided, they may be embodied in a single memory medium. The first setup information management unit 16 and the second setup information management unit 171 may be merged in a single setup information management unit.

### Third Embodiment

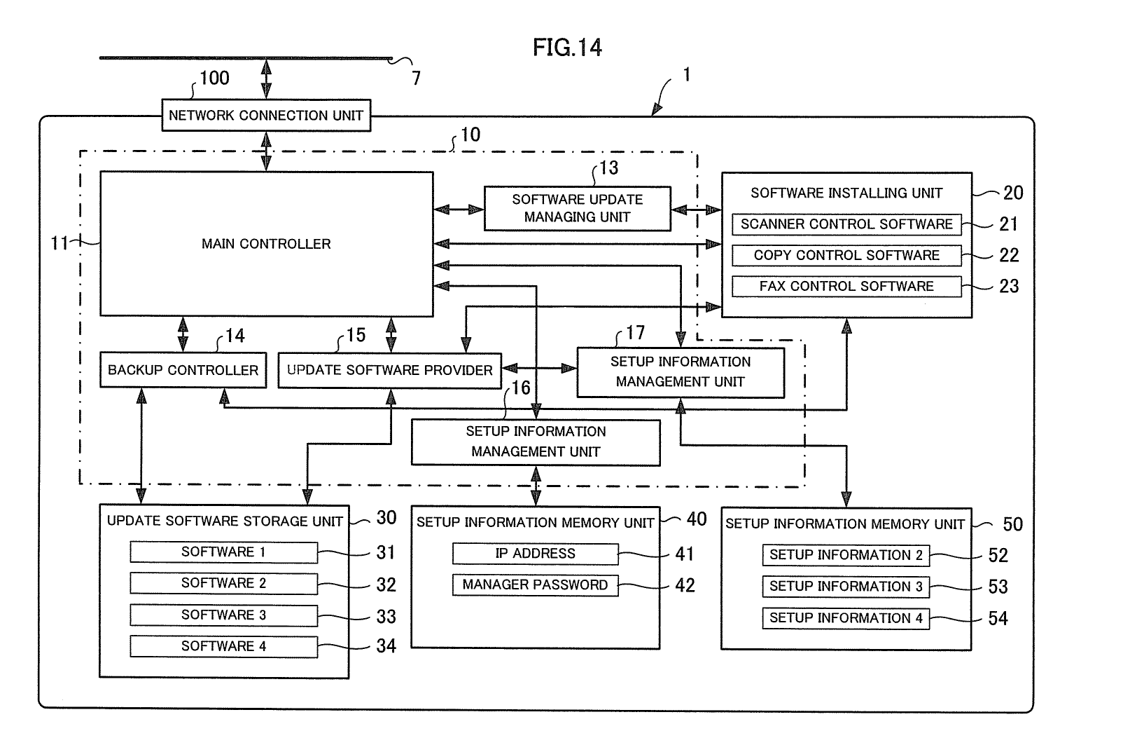

An image forming apparatus in a management system according to a third embodiment of the invention will be described with reference to FIG. 14.

FIG. 14 is a block diagram illustrating a configuration of a first managing MFP 1 according to the third embodiment of the invention. Elements having the same functions as the elements of the first or second embodiment are denoted by the same reference numerals.

In this embodiment, the control software 21, 22, and 23 of the first managing MFP 1 is installed in the software installing unit 20 and is also stored as the control software 31 (software 1) in the updating software storage unit 30. The control software 31 stored in the updating software storage unit 30 is stored in such a format that it can be transmitted through the network.

Accordingly, the software re-converter 12 shown in FIG. 2 can be omitted from the first managing MFP 1 shown in FIG. 14.

According to the invention described above, it is possible to provide a management system of image forming apparatuses which can sufficiently maintain and manage the image forming apparatuses connected to a network.

Although it has been described that another MFP substitutively performs the management function when the first managing MFP 1 is out of order, another MFP may substitutively perform the management function, for example, even when the first managing MFP 1 is not turned on and does not work normally.

By providing a rollback function to the first managing MFP 1 or other MFPs 2, 3, and 4, it is possible to suppress damage when a disorder occurs at the time of installation, thereby enhancing restoration workability.

The invention is not limited to the above description, but may be modified in various forms without departing from the scope of the appended claims.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. A management system for managing a plurality of image forming apparatuses connected to each other through a network, comprising:
a first image forming apparatus has a function of managing the other image forming apparatuses operative under program control:
to store unique setup information of the first image forming apparatus and the other image forming apparatuses received through the network in a first memory unit;
to store control software of controlling a function of the first image forming apparatus and functions of the other image forming apparatuses in a first software storage unit;
to transmit updating control software to the other image forming apparatuses on the basis of the setup information stored in the first memory unit at the time of updating the control software; and
to designate one of the other image forming apparatuses and transmits the setup information and the control software of the plurality of image forming apparatuses connected to each other through the network to the designated image forming apparatus as backup data, and
a second image forming apparatus designated by the first image forming apparatus operative under program control:
to transmit unique second setup information of the second image forming apparatus to the first image forming apparatus;
to store the control software transmitted from the first image forming apparatus in a second control software storage unit;
to update the control software and transmits the updated second setup information to the first image forming apparatus when receiving the updating control software from the first image forming apparatus;
to store the setup information included in the backup data in a second memory unit when receiving the backup data from the first image forming apparatus;
to store the control software included in the backup data in the second control software storage unit; and
to substitutively perform the management of the other image forming apparatuses over the network when the first image forming apparatus stops its work.

2. The management system, according to claim 1, wherein the second image forming apparatus monitors a working state of the first image forming apparatus at a predetermined time and performs a management function instead of the first image forming apparatus when determines that the first image forming apparatus stops its work.

3. The management system, according to claim 2, wherein the monitoring operation of the second image forming apparatus is performed at the time of starting up the second image forming apparatus or at the time of accessing the network.

4. The management system, according to claim 2, wherein the monitoring operation of the second image forming apparatus is performed at a predetermined time interval when the second image forming apparatus is working.

5. The management system, according to claim 1, wherein the control software of the first image forming apparatus is transmitted from the first image forming apparatus to the image forming apparatus of the same model when the other image forming apparatuses include the same model as the first image forming apparatus.

6. The management system, according to claim 1, wherein the first image forming apparatus or the second image forming apparatus substitutively performing the management function transmits differential data between software stored in the other image forming apparatuses and the newest software to the other image forming apparatuses as the updating software.

7. The management system, according to claim 1, wherein the first image forming apparatus has an operation panel and displays on the operation panel a fact that the updated setup information is received when receiving the update setup information.

8. The management system, according to claim 1, wherein a manager computer is additionally connected to the network and notifies the manager computer of a fact that the control software is updated when the control software is updated.

9. The management system, according to claim 1, wherein the first image forming apparatus comprising:
a first network connection unit configured to transmit and receive data to and from the other image forming apparatuses through the network;
a first memory unit configured to store unique setup information of the first image forming apparatus and unique setup information of the other image forming apparatuses received through the network;
a first setup information management unit configured to manage the setup information stored in the first memory unit;
a first software storage unit configured to store control software for controlling functions of the first image forming apparatus and functions of the other image forming apparatuses;
a first software update management unit configured to transmit updating control software to the other image forming apparatuses on the basis of the setup information stored in the first memory unit at the time of updating the control software; and
a first backup controller configured to designate a second image forming apparatus of the other image forming apparatuses connected to the network and transmit to the second image forming apparatus the setup information stored in the first memory unit and the control software stored in the software storage unit as backup data.

10. The management system, according to claim 1, wherein the second image forming apparatus comprising:
a second network connection unit configured to transmit and receive data to and from the other image forming apparatuses including the first image forming apparatus through the network;
a second memory unit configured to store unique second setup information of the second image forming apparatus;
a second control software storage unit configured to store control software of the second image forming apparatus transmitted from the first image forming apparatus;
a second software update management unit configured to store the updating control software in the second control software storage unit when receiving the updating control software transmitted from the first image forming apparatus;
a second setup information management unit configured to manage the second setup information stored in the second memory unit and transmit the updated second setup information to the first image forming apparatus when the second setup information is updated; and
a second backup controller configured to store the setup information included in the backup data transmitted from the first image forming apparatus in the second memory unit and store the control software included in the backup data in the second control software storage unit.

11. An image forming apparatus which can be connected to a plurality of different image forming apparatuses through a network and which has a function of managing the plurality of different image forming apparatuses, the image forming apparatus comprising:
a network connection unit configured to transmit and receive data to and from the different image forming apparatuses through the network;
a memory unit configured to store unique setup information of the image forming apparatus and unique setup information of the different image forming apparatuses received through the network;
a software storage unit configured to store control software for controlling functions of the image forming apparatus and functions of the different image forming apparatuses;
a software update management unit configured to transmit updating control software to the corresponding different image forming apparatuses on the basis of the setup information stored in the memory unit at the time of updating the control software; and
a backup controller configured to designate any one of the different image forming apparatuses connected to the network and back up the setup information stored in the memory unit and the control software data stored in the software storage unit in the designated image forming apparatus,
wherein, when the image forming apparatus steps its work, the designated image forming apparatus substitutively performs the management of the different image forming apparatuses.

12. The image forming apparatus according to claim 11, wherein the setup information includes one of an IP address, a manager password, a model code, and version information of the control software of the respective image forming apparatuses.

13. The image forming apparatus according to claim 11, wherein the updating software includes differential data between the software stored in the different image forming apparatuses and the newest software.

14. The image forming apparatus according to claim 11, wherein a priority order is given to the different image forming apparatuses connected to the network and the substitutive image forming apparatus is designated in accordance with the priority order.

15. The image forming apparatus according to claim 11, wherein the image forming apparatus having many resources of the different image forming apparatuses connected to the network is designated as the substitutive image forming apparatus.

16. A management system for managing a plurality of image forming apparatuses connected to each other through a network, comprising:
a first image forming apparatus has a function of managing the other image forming apparatuses operative under program control:
to store unique setup information of the first image forming apparatus and unique setup information of the other image forming apparatuses received through the network in a first memory unit;
to store control software of controlling a function of the first image forming apparatus and functions of the other image forming apparatuses and management software of preparing a management function unit for managing the other image forming apparatuses in a first software storage unit;
to transmit updating control software to the other image forming apparatuses on the basis of the setup information stored in the first memory unit at the time of updating the control software; and
to designate one of the other image forming apparatuses and transmits the setup information and the control software of the plurality of image forming apparatuses connected to each other through the network to the designated image forming apparatus as backup data along with the management software, and
a second image forming apparatus designated by the first image forming apparatus operative under program control:
to transmit unique second setup information of the second image forming apparatus to the first image forming apparatus;
to store the control software transmitted from the first image forming apparatus in a second control software storage unit;
to update the control software and transmits the updated second setup information to the first image forming apparatus when receiving the updating control software from the first image forming apparatus;
to store the setup information included in the backup data in a second memory unit and stores the control software included in the backup data in the second control software storage unit, when receiving the backup data from the first image forming apparatus;
to install the management software transmitted from the first image forming apparatus and forms the management function unit in memory areas of the second memory unit and the second control software storage unit; and
to substitutively perform the management of the other image forming apparatuses over the network when the first image forming apparatus stops its work.

17. The management system according to claim 16, wherein the second image forming apparatus includes a storage area for storing the installed management software in the second control software storage unit.

18. The management system according to claim 16, wherein the second image forming apparatus monitors a working state of the first image forming apparatus at a predetermined time and performs a management function instead of the first image forming apparatus when determines that the first image forming apparatus stops its work.

19. The management system according to claim 16, wherein the first image forming apparatus comprising:
a first network connection unit configured to transmit and receive data to and from the other image forming apparatuses through the network;
a first memory unit configured to store unique setup information of the first image forming apparatus and unique setup information of the other image forming apparatuses received through the network;
a first setup information management unit configured to manage the setup information stored in the first memory unit;
a first software storage unit configured to store control software for controlling functions of the first image forming apparatus and functions of the other image forming apparatuses;
a first software update management unit configured to transmit updating control software to the other image forming apparatuses on the basis of the setup information stored in the first memory unit at the time of updating the control software;
a first management software storage unit configured to store management software for preparing a management function unit for managing the other image forming apparatuses;
a first backup controller configured to select the second image forming apparatus connected to the network and transmit to the second image forming apparatus the setup information stored in the first memory unit and the control software stored in the software storage unit as backup data; and
a software provider configured to select the second image forming apparatus from the other image forming apparatuses connected to the network and transmit the management software to the second image forming apparatus.

20. The management system according to claim 16, wherein the second image forming apparatus comprising:
a second network connection unit configured to transmit and receive data to and from the other image forming apparatuses including the first image forming apparatus through the network;
a second memory unit configured to store unique second setup information of the second image forming apparatus;
a second control software storage unit configured to store control software of the second image forming apparatus transmitted from the first image forming apparatus;
a second software update management unit configured to store the updating control software in the second control software storage unit when receiving the updating control software transmitted from the first image forming apparatus;
a second setup information management unit configured to manage the second setup information stored in the second memory unit and transmit the updated second setup information to the first image forming apparatus when the second setup information is updated;
a management function unit formed in memory areas of the second memory unit and the second control software storage unit by installing the management software transmitted from the first image forming apparatus; and
a second backup controller configured to store the setup information included in the backup data transmitted from the first image forming apparatus in the second memory unit and store the control software included in the backup data in the second control software storage unit.
